(19) United States
(12) Patent Application Publication
(10) Pub. No.: US 2009/0212779 A1
(43) Pub. Date: Aug. 27, 2009

(54) Battery Sensor Unit

(76) Inventor: Christoph Wenger, Korntal-Muenchingen (DE)

Correspondence Address: KENYON & KENYON LLP, ONE BROADWAY, NEW YORK, NY, 10004, US

(21) Appl. No.: 11/989,465

(22) PCT Filed: Jul. 4, 2006
(86) PCT No.: PCT/EP2006/063828

§ 371 Date: Mar. 31, 2009

(30) Foreign Application Priority Data
Aug. 19, 2005 (DE) 102005039587.2

(51) Int. Cl. G01N 27/416

(52) U.S. Cl. 324/426; 29/428

(57) ABSTRACT

A battery sensor unit having a fastening device for fastening the battery sensor unit to a contact of a battery, in particular a motor vehicle battery, and having a measuring section for acquiring the state of the battery, the measuring section and the fastening device being combined to form an integral assembly. The measuring section is fashioned in the shape of a cylinder. In addition, a method for connecting the fastening device of the battery sensor unit to the cylindrically fashioned measuring section is described.

### FIELD OF THE INVENTION

The present invention relates to a battery sensor unit having a fastening device and a measuring section, as well as to a method for connecting a fastening device of a battery sensor unit having a measuring section.

### BACKGROUND INFORMATION

For recognizing the state of batteries in motor vehicles, generally, the quantities temperature, current, and/or voltage are acquired and are processed using suitable algorithms. A microcontroller or a corresponding computing unit is typically used here. For the current acquisition, in general measurement shunts and inductive current sensors, such as compensation sensors, flux gate elements, or Hall elements are used.

European Patent No. EP-A-1 435 524 describes a battery sensor device that has a fastening device that is capable of being connected directly to a terminal of a motor vehicle battery, the fastening device and a battery sensor being combined to form an integrated assembly. The battery sensor device is adapted in its shape and size to standard battery terminal casings. In addition, the battery sensor is made up of a planar measurement shunt and an electronic unit, the measurement shunt being constructed as a resistive element having two resistive terminals fashioned as mechanical carriers.

### SUMMARY

An example battery sensor unit according to the present invention having a fastening device for fastening the battery sensor unit to a contact of a battery, in particular a battery of a motor vehicle, and having a measuring section for acquiring the state of the battery, the measuring section and the fastening device being combined to form an integral assembly, may have the advantage that no constructive modifications are needed in order to change the cable exit direction. For this purpose, it is provided that the measuring section is fashioned to have a cylindrical shape. The geometry of the measuring section thus ensures a very high degree of mechanical stability of the battery sensor unit due to the welding method that can be used, or a flexural strength that is nearly constant in all directions of the measuring section. In addition, there results a significant cost advantage in comparison with conventional terminal and connection technology.

Advantageously, the measuring section of the battery sensor unit may be welded on a first side to the fastening device, and may be provided, on another side situated opposite the first side, with a cable receptacle for a battery cable. Here, the cable receptacle can be connected to the battery cable by soldering, cold welding, or a corresponding connecting technique, while for the connection between the fastening device and the measuring section on the one hand and the measuring section and the cable receptacle on the other hand a friction welding method is suitable.

In order to optimize the welded connection and/or the thermoelectric characteristic of the battery sensor unit, in an alternative embodiment it is provided to situate a copper layer between the measuring section and the fastening device.

The measuring section itself is made of a resistant material, in particular manganin, and is fashioned as a measurement shunt. In addition, it is possible to manufacture either the entire battery sensor unit from a resistant material, in particular manganin, or, in contrast to the measuring section, to fashion the fastening device and the cable receptacle from copper or a corresponding material having very good electrical conductivity.

In an advantageous construction, as a result of the very compact construction the outer dimensions of the battery sensor unit generally do not exceed the dimensions of a contact recess of the battery, so that the battery sensor unit fits largely or completely into the contact recess, and in addition no constructive modifications are required for the various cable exit directions. Thus, the cited dimensions include at least a length and width extension.

### BRIEF DESCRIPTION OF THE DRAWINGS

The present invention is explained in exemplary fashion below on the basis of figures; identical reference characters in the Figures designate identical components having identical functions.

FIG. 1 shows a first view of an exemplary embodiment of a battery sensor unit according to the present invention.

FIG. 2 shows a second view of the exemplary embodiment of the battery sensor unit according to the present invention.

### DETAILED DESCRIPTION OF EXAMPLE EMBODIMENTS

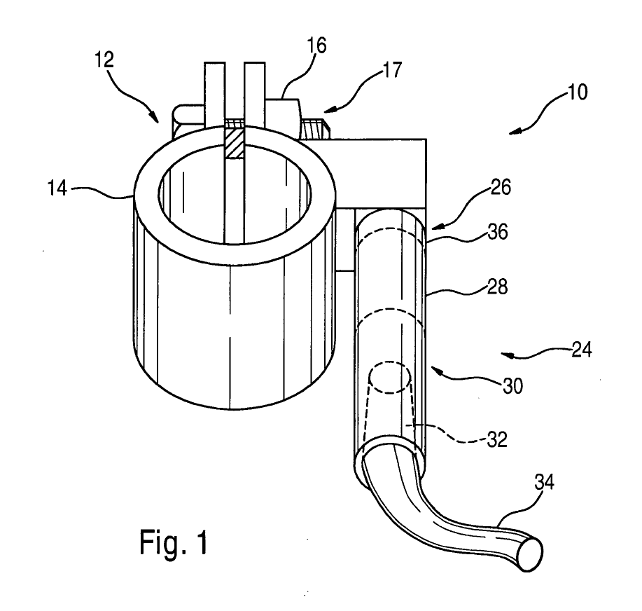

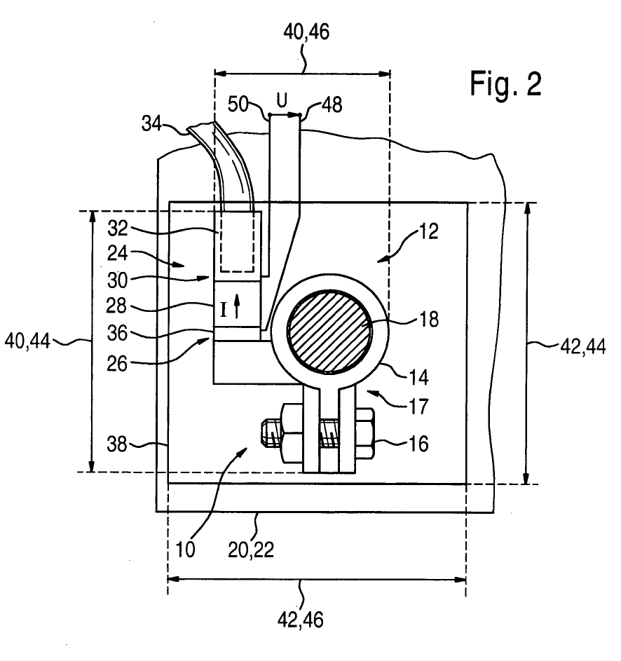

FIG. 1 shows a first view of an exemplary embodiment of battery sensor unit 10 according to the present invention. Battery sensor unit 10 is made up on the one hand of a fastening device 12 that can be connected, by a clamping screw 16 in the form of a terminal clamp 17 that acts on a clamping element 14, to a contact 18 or terminal of a battery 20, in particular a motor vehicle battery 22 (see FIG. 2). On the other hand, battery sensor unit 10 is made up of a measuring section 24 that is combined with fastening device 12 in an integral assembly on a first side 26. Due to the cylindrical construction of measuring section 24, there results the possibility of an economical, direct friction welding between measuring section 24 and fastening device 12. However, other welded connections are also possible.

Measuring section 24 is fashioned as a measurement shunt 28, and is made of a resistant material, in particular manganin. While first side 26 is welded to fastening device 12, another side 30, situated opposite first side 26, has a cable receptacle 32 for a battery cable 34 that can be made either of copper or, as is measurement shunt 28, of a resistant material, and that is also welded to measuring section 24.

In order to optimize the welded connection on first side 26 and/or to optimize the thermoelectrical characteristic of battery sensor unit 10, a copper layer 36 is situated between measuring section 24 and fastening device 12. This is advantageous in particular if not only measuring section 24 but also fastening device 12 is made of manganin or of some other resistant material. Alternatively, however, copper layer 36 can also be omitted, so that the overall battery sensor unit 10, including cable receptacle 32, is made of a resistant material. If, in contrast, fastening unit 12 is made of copper, it is in any case not necessary to use copper layer 36.

FIG. 2 shows a top view of the exemplary embodiment of battery sensor unit 10 according to the present invention, whose other reference characters agree with those in FIG. 1.

Battery sensor unit 10 is capable of being connected, via clamping element 14, which can be narrowed using clamping screw 16, to the contact 18 or terminal of battery 20 that is countersunk in a contact recess 38 or terminal recess. Due to the cylindrical construction of measuring section 24, a very compact construction of battery sensor unit 10 is possible, so that its dimensions 40 advantageously generally do not exceed dimensions 42, in particular a length extension 44 and width extension 46, of contact recess 38.

In order to acquire the state of battery 20, via measurement shunt 28 a battery voltage U due to a flowing battery current I is measured at a first and second measurement pickoff point 48 or 50, and is forwarded to a computing unit (not shown), for example a microcontroller, for evaluation. Measurement pickoff points 48 and 50 can be attached to the areas of cable receptacle 32 and of fastening device 12 adjacent to measurement shunt 28, or to copper layer 36, or can be attached with a defined distance on measurement shunt 28.

Finally, it is also to be noted that the depicted exemplary embodiment is limited neither to FIGS. 1 and 2 nor to the depicted shape of fastening device 12 or of clamping screw 16 that is used, nor to the depicted construction of cable receptacle 32. Thus, for example it is possible, without limitation of the present invention, for the relative size relations to be different between measurement shunt 28 and cable receptacle 32, or measuring section 24 and fastening device 12.

1-14. (canceled)

15. A battery sensor unit comprising:
a fastening device adapted to fasten the battery sensor unit to a contact of a motor vehicle battery; and
a measuring section adapted to acquire a state of the battery, the measuring section and the fastening device being combined to form an integral assembly, the measuring section having a cylindrical shape.

16. The battery sensor unit as recited in claim 15, wherein the measuring section is welded on a first side to the fastening device and has, on another side, situated opposite the first side, a cable receptacle for a battery cable.

17. The battery sensor unit as recited in claim 15, wherein the measuring section is made of manganin.

18. The battery sensor unit as recited in claim 15, wherein a copper layer is situated between the measuring section and the fastening device.

19. The battery sensor unit as recited in claim 15, wherein the measuring section is fashioned as a measurement shunt.

20. The battery sensor unit as recited in claim 15, wherein the fastening device is a terminal clamp.

21. The battery sensor unit as recited in claim 15, wherein the battery sensor unit is made of manganin.

22. The battery sensor unit as recited in claim 15, wherein dimensions of the battery sensor unit do not exceed dimensions of a contact recess of the battery.

23. The battery sensor unit as recited in claim 22, wherein the dimensions include at least a length extension and a width extension.

24. A method for connecting a fastening device of a battery sensor unit to a measuring section, comprising:
fashioning the measuring section to have a cylindrical shape; and
welding the measuring section to the fastening device in an integral assembly.

25. The method as recited in claim 24, wherein the measuring section and the fastening device are connected to one another by friction welding.

26. The method as recited in claim 24, further comprising:
inserting a copper layer between the measuring section and the fastening device.

27. The method as recited in claim 24, wherein the measuring section is fashioned to have, on another side, situated opposite the first side, a cable receptacle that is connected to a battery cable.

28. The method as recited in claim 24, wherein the fastening device is a terminal clamp.
